(19) United States
(12) Patent Application Publication
(10) Pub. No.: US 2010/0070309 A1
(43) Pub. Date: Mar. 18, 2010

(54) Method and System for Assessing Insurance Risk

(76) Inventors: Martin W. Deede, Coventry, RI (US); Philip J. Jennings, Hope Valley, RI (US); David McMichael, Warwick, RI (US)

Correspondence Address: MORGAN LEWIS & BOCKIUS LLP, 1111 PENNSYLVANIA AVENUE NW, WASHINGTON, DC, 20004, US

(21) Appl. No.: 12/424,327

(22) Filed: Apr. 15, 2009

Related U.S. Application Data
(60) Provisional application No. 61/045,231, filed on Apr. 15, 2008.

(51) Int. Cl. G06Q 40/00; G06Q 50/00

(52) U.S. Cl. 705/4

(57) ABSTRACT

The disclosed technology provides systems and methods for estimating the risk of loss for a location. A computer implemented method in accordance with the disclosed technology accesses one or more geographical characteristics associated with a geographical address, considers a plurality of perils and for each peril, computes a corresponding measure of peril that indicates a risk of loss at the geographical address from that peril. The corresponding measure of peril is computed based on the geographical characteristic(s) associated with the geographical address. The individual measures of peril are combined to form a combined measure that indicates a combined risk of loss at the geographical address from the plurality of perils. In one embodiment, the combined measure is used to compute an insurance premium for property at the geographical address. The disclosed technology also includes a computer executing software, wherein the executed software causes the computer to perform the steps above.

### CROSS-REFERENCE TO RELATED APPLICATIONS

This application claims the benefit of priority of U.S. Provisional Patent Application No. 61/045,231 filed Apr. 15, 2008, the entire contents of which are hereby incorporated herein by reference.

### FIELD OF INVENTION

The invention relates generally to methods for using Geocoded data pertaining to the physical environment in combination with historical insurance data to develop more accurate and efficient methods for insurance claim risk assessment at an individual risk level that can be used for more accurately pricing and underwriting insurance. Geocoded data is information assigned to specific geographic locations. More effective individual level risk assessment for an exact location can be accomplished by using the Geocode of the particular location to link risk attributes of various types for the location with historical insurance data. This linked information is then analyzed and an enhanced risk assessment is developed (“Geospatial Score”). The invention also relates generally to the means by which the improved risk assessment can be efficiently employed in pricing and underwriting mechanisms.

### BACKGROUND OF THE INVENTION

A Geocode is a numerical value assigned to a geographical location associated with an entity such as a building, structure, parcel, lot, or dwelling, among other things (“Entities”). Often, such Entities are identified by street address, in which case the entities are called street-addressable Entities. Geocoding is the process that associates a specific numerical value with geographical location, such as a pair of latitude-longitude coordinates, with the street address or other identifier of the Entity. Geocodes help in enhancing understanding of the risk associated with insuring Entities. Such understanding of the risk associated with geographic relationships is critical in many areas, including, but not limited to insurance pricing and underwriting.

Insurance companies must evaluate expected losses in determining the rates to be charged for insurance coverage to protect against those losses. Currently, expected losses for many types of insurance, such as casualty and property insurance, are determined by reference to a selected geographic territory. More specifically, a geographic territory is first defined or selected, and expected losses per insured risk are then calculated for that territory. The basic rate charged for insurance coverage, before individual risk factors other than location are considered, is the same for all specific locations within that geographic territory.

The current method does not reflect the fact that expected losses may vary significantly for different locations within a geographic territory.

In addition, the rates charged for insurance coverage may vary from one geographic territory to the next.

It is, therefore, an object of the invention to provide a more accurate method of evaluating expected losses at given geographic locations for the purpose of establishing insurance rates for those locations.

It is a further object of the invention to eliminate significant differences between the insurance rates charged at adjacent or nearby locations.

### SUMMARY OF THE INVENTION

It is an object of the invention to provide improved methods for assessing the insurance risk at a given location, i.e., “individual level risk assessment” by combining Geocoded information for the precise location—linked by means of the Geocode for the location—with historical insurance data. In an embodiment of the invention, the method includes identifying various risk factors for a particular location including, but not limited to, (i) distance to coast; (ii) windpool eligibility determination; (iii) distance to earthquake faultline; (iv) distance to sink hole, (v) brushfire risk, (vi) elevation, (vii) historical weather patterns; and (viii) additional attributes derived from the aforementioned attributes, both singly' and in combination. Examples of factors included in category (viii) are “viewshed” and “slope,” which may be derived from elevation data, and an indicator for “low elevation and close proximity to coast,” derived from a combination of factors.

An embodiment of the invention provides a method for calculating the insurance risk associated with a street-addressable Entity based on the Geocoded variables.

Embodiments of the current invention may be implemented, wholly or in part, as computer-implemented methods. For example, various embodiments of the current invention may be implemented on a network-enabled computer system.

Other features and advantages of the invention will become more apparent when considered in connection with the accompanying drawings and detailed description.

### BRIEF DESCRIPTION OF THE DRAWINGS

In the drawings:

FIG. 1 is block diagram of one embodiment of a networked information and computing system; and

FIG. 2 is a flow diagram of one exemplary way to compute a Geospatial Score indicating a measure of risk of loss.

### DETAILED DESCRIPTION

A “Geocode” is a code that specifies a single geographical position of an Entity. An “Entity” includes, but is not limited to, a building, structure, parcel, lot, or dwelling, among other things. Geocoding is the process of assigning geographic identifiers (e.g. codes or geographic coordinates expressed as latitude-longitude) to map features and other data records, such as street addresses, intersections, region names, or landmark names. Entities are buildings, structures, lots, properties, or other geographical regions. In some cases, large regions may be Geocoded. For example, a zip code region, uniquely identified by its zip+4 code, may be Geocoded based on the geographic position of the centroid of the zip code region. Similarly, when a house is Geocoded, a single position somewhere in or near the house is selected and associated with a unique identifier, such as a street address, for the house.

In addition to the above, anything that has a geographic component can be Geocoded. For example, the location where a picture was taken can be Geocoded. With geographic coordinates, the features can then be mapped and entered into a geographic information system,

A street-addressable Entity is a physical structure or region that may be identified using a street address. Examples of street-addressable Entities include, but are not limited to: houses, empty lots, buildings, apartments, apartment buildings, condominiums, building complexes and landmarks, as well as parking garages. Street addressable Entities also include various associated structures or physical features such as, for example, roofs, solar panels, solar heaters, air conditioners, skylights, driveways, fences, sheds, patios, decks, docks, pools, diving boards, hot tubs, statues/statuettes, satellite dishes, tennis courts, trampolines, bushes, shrubs, grass, trees, gardens, and landscaping. A street-addressable Entity may be a compound street addressable Entity composed of multiple constituent entities. For example, an estate that includes a house, garage, pool, driveway, tennis court, patio, driveway, and extensive landscaping may be regarded as a single street addressable Entity. Such a compound street addressable Entity may be used in place of, or in addition to, its constituent entities.

A street-addressable Entity may be Geocoded by specifying an associated map position. For example, the centroid of an empty lot, home, building, or region may be used as a Geocode for these addressable Entities. In some cases, street-addressable Entities may be identified using polygons, such as for instance parcel maps, and/or aerial or satellite images. Typically, parcel maps may be used to identify property lines for properties, including commercial properties and empty lots. In some cases, polygons may be used to identify boundaries of certain addressable Entities and to calculate their areas and/or perimeters. Alternately, some street addressable Entities may be identified using aerial or satellite imagery. For example, a satellite image of a suburban neighborhood may contain recognizable image features such as driveways and rooftops. In some cases, a potential list of street addressable Entities may be produced based on the analysis of aerial or satellite images. For example, a list may be generated by identifying all of the rooftops in a neighborhood and then assuming that each rooftop represents a single street addressable Entity. However, depending on the techniques used, the list generated from aerial or satellite images alone may not be completely accurate. For example, in a neighborhood with condominiums, some rooftops may represent two or more street addressable Entities: due to poor weather conditions, some portions of the neighborhood may not be visible in the aerial or satellite image.

An embodiment of the invention relates to the use of geographical data describing the exact location and the immediate vicinity of the insured property or location. The use of this geospatial intelligence will result in pricing insurance risks more accurately, better understanding risk concentration in hazard prone areas, and underwriting risks more effectively and efficiently.

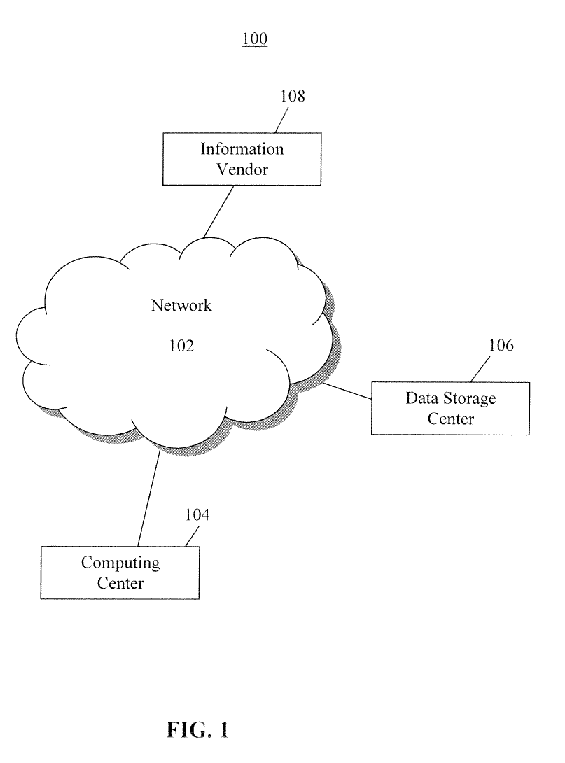

Referring now to FIG. 1, there is shown a block diagram of one embodiment of a networked information and computing system 100 that can store, communicate, process, and/or use the information described above. The information and computing system 100 includes a network 102 that may include one or more telecommunication devices such as routers, hubs, gateways, and the like, as well as one or more connections such as wired connections or wireless connections. In different embodiments, the network 102 can include different numbers of telecommunication devices and connections and can span a range of different geographies. In different embodiments, the network 102 can include, among other things, all or portions of a wired telephone infrastructure, a cellular telephone infrastructure, a cable television infrastructure, and/or a satellite television infrastructure.

Various components of the information and computing system 100 are in communication with the network 102, including computing centers 104, data storage centers 106, and information vendors 108. Each of these components 104-108 can include one or more computers and/or storage devices. As used herein, the term “computer” includes any system or device that can execute machine instructions, including, for example, desktops, laptops, servers, supercomputers, handheld devices, and/or networked or distributed computing systems, or multiples or combinations thereof. A computer can include hardware such as network communication devices, storage medium/devices, processors, memory, computer boards, optical or magnetic drives, and/or human interface devices, and software such as operating system software, server software, database management software, software supporting various communication protocols, and/or software supporting various programming languages. The information described above, such as aerial or satellite images, street addresses, Geocodes, and/or other geographic data, can be stored by the computing center 104, the data storage center 106, and/or the information vendor 108, and can be communicated among them.

An embodiment of the invention uses information based on the exact location, as defined by the latitude and longitude, of the insured dwelling. After using the Geocode to link risk attributes to the exact location, a Geospatial Score may be calculated that estimates risk of loss at the location from the linked risk attributes.

Additional risk factors that may be considered include, but are not limited to, the distance to various hazard features such as coastline, fault-line, and brushfire risk. Actuarial research has shown that there exists a measurable difference in expected insurance losses based on the previously-referenced risk factors. The impact of these risk factors on expected insurance losses varies depending on the peril (cause of loss) considered. For example, a fire peril impacts insurance claims differently than insurance claims due to a hail peril. The Geospatial Score is developed considering the impact of these variables on each peril independently and then combined to arrive at a score for a given dwelling that reflects the overall relative risk of an insurance loss for that dwelling based on the exact location and the immediate surrounding geographical area of that location.

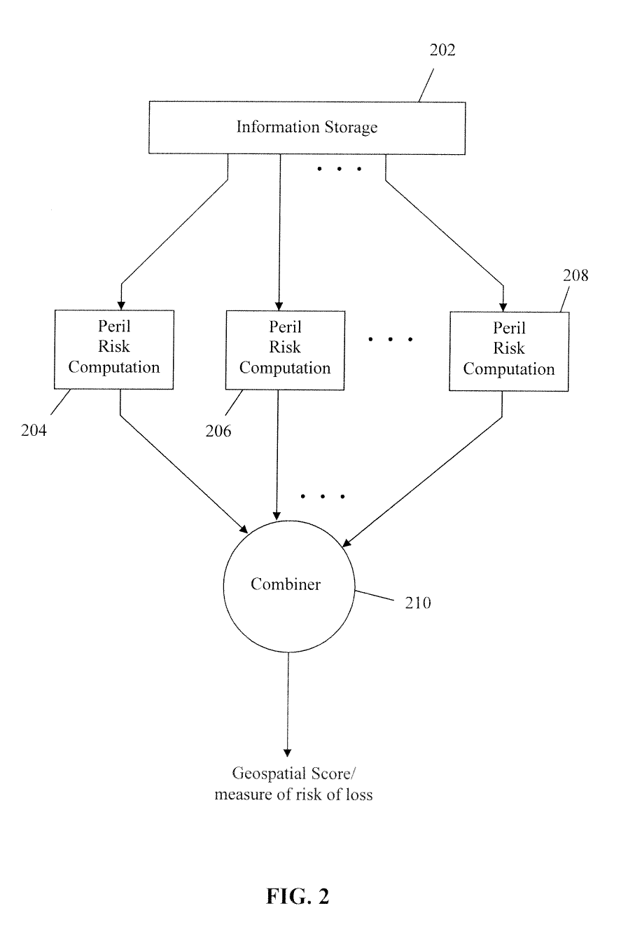

FIG. 2 shows a flow diagram of an exemplary Geospatial Score computation in accordance with one aspect of the disclosed technology. As used herein, a “Geospatial Score” refers to a measure of risk of loss for property, such as partial or complete damage to buildings, dwellings, and other types of property. Information used to compute a Geospatial Score can be stored in an information storage 202, which can be wholly located in or distribute across one or more of the components 104-108 of FIG. 1. The information in the storage 202 can include any of the information described above, including aerial or satellite images, street addresses, Geocodes, geographical characteristics (such as elevation, slope, and/or aspect), other geographic data, risk attribute data, historical insurance data, and/or locations of various hazard features (such as coastline, fault-line, and brushfire risk). In one embodiment, the information storage 202 can include a National Residential Address List of approximately 140 million addresses. Computation blocks 204-210 can compute a Score for each of these addresses.

In one aspect of the disclosed technology, a Geospatial Score for an address (that is, a measure of risk of loss of property at an address) can be computed based on one or more perils that present a risk of loss to the property. For example, perils can include loss from fire, wind, hail, water, and other types of perils such as loss from earthquakes. The foregoing list of perils is exemplary and does not limit the scope of the disclosed technology. Those skilled in the art will recognize other types of perils, and the disclosed technology is contemplated to apply to such other perils as well.

In one embodiment, risk of loss at the address from multiple perils can be computed. For example, in the illustrated embodiment of FIG. 2, a risk of loss from fire 204, a risk of loss from water 206, and a risk of loss from hail 208, can each be computed. In one embodiment, each peril risk computation can consider different types of information or geographical characteristics. A peril risk computation can apply one or more risk models for that peril to the information and/or geographical characteristics. As used herein, the term “model” refers to any operation that receives one or more input values and generates one or more output values based on the input value(s). Those skilled in the art will recognize that a model can be implemented by a “real-time” mathematical computation or by a look-up table that retrieves pre-computed values. Those skilled in the art will also recognize that risk of loss models can be generated from historical insurance claim data, predictive analytic techniques, and/or other forward-looking or backward-looking actuarial data and/or techniques. In one embodiment, the input value to a risk of loss from fire model can be a Geocode of an address. The model can compute the distance between the address's Geocode and the Geocodes for areas of relatively high bushfire risk, and use the computed distance to determine risk of loss at the address from fire.

In one embodiment, a risk of loss at the address from hail can consider the proximity/distance between the address and a coast, such as a lake, gulf, ocean, or other body of water. Such a computation can refer to a risk model that indicates risk of loss from hail based on an address's distance from the coast. The input value to a risk of loss from hail model can be a Geocode of an address. The model can compute the distance between the address's Geocode and the Geocodes for coasts, and use the computed distance to determine risk of loss at the address from hail.

In one embodiment, a risk of loss at the address from hail or wind can consider the slope of land at or surrounding an address Such a computation can refer to a risk model that indicates risk of loss from hail or wind based on slope. The input value to a risk of loss from hail/wind model can be a slope at or surrounding an address. The model can use the input slope to determine risk of loss at the address from hail or wind.

In one embodiment, a risk of loss at the address from hail can consider both the slope of land at or surrounding an address and the aspect of the land. Such a computation can refer to a risk model that indicates risk of loss from hail based on both slope and aspect. The input values to a risk of loss from hail model can include a slope at or surrounding an address and an aspect of the land at the address. The model can use the input slope and aspect to determine risk of loss at the address from hail.

In one embodiment, a risk of loss at the address from lightning can consider both the slope of land at or surrounding an address and the aspect of the land. Such a computation can refer to a risk model that indicates risk of loss from lightning based on both slope and aspect. The input values to a risk of loss from lightning model can include a slope at or surrounding an address and an aspect of the land at the address. The model can use the input slope and aspect to determine risk of loss at the address from lightning.

Referring again to FIG. 2, in one embodiment, the measures of peril computed by the peril risk computation blocks 204-206 can measure relative risk. In one embodiment, relative risk can be a measure that compares risk of loss at an address from a peril with an average risk of loss from that peril in a particular region. In this embodiment, the relative risk measure will be “one” if the risk of loss at an address from a peril is the same as an average risk of loss from that peril in the region. In one embodiment, if the risk of loss at an address from a peril is less than as an average risk of loss from that peril, then the relative risk measure will be less than “one.” On the other hand, if the risk of loss at an address from a peril is greater than as an average risk of loss from that peril, then the relative risk measure will be greater than “one.”

With continuing reference to FIG. 2, in one aspect of the disclosed technology, the measures of peril computed by the peril risk computation blocks 204-208 can be combined by a combiner block 210 to generate a Geospatial Score. There are many ways to combine the various measures of peril corresponding to different perils. In one embodiment, the combiner block 210 can compute a weighted sum of the measures of peril to be the Geospatial Score. In one embodiment, the weights for each measure of peril can be a percentage value that indicates the percentage of paid insurance claims that involve the peril.

In one embodiment, after a Geospatial Score is computed for an address, it can be associated with the address and stored in the information storage 202. The Geospatial Score can be maintained for use as a look-up table at the time of a new business quote and renewal for pricing and underwriting. In this way, a pre-calculated Geospatial Score is used as one of the variables in a homeowners tier-rating program. This allows for differentiation in risk exposure, and consequently, the premium to be charged to each policyholder within any geographic area (e.g., within a zip code or a census block) will vary based on exact location geo-referenced characteristics. The use of a look-up table rather than a “real-time” determination of the insurance risk at the exact location greatly increases efficiency of implementation of the pricing and underwriting methods of the invention.

Those skilled in the art will recognize that computation blocks 204-210 can be implemented by software instructions executing on one or more computers. As described above, the term “computer” includes any system or device that can execute machine instructions, including, for example, desktops, laptops, servers, supercomputers, handheld devices, and/or networked or distributed computing systems, or multiples or combinations thereof. In one embodiment, the computers implementing the computation blocks 204-210 can be located at the computing center 104 of FIG. 1. Addresses and Geospatial Scores can be stored in any component 104-108 of FIG. 1.

One aspect of the disclosed technology provides a method and a system for using a Geospatial Score to assign an appropriate insurance rate level for the Entity. An example of such a calculation is provided below. The example compares the rates calculated by prior art methods (territorial base rates) with the Geospatial Score technology disclosed herein, and calculates the demonstrable savings achieved for a policy holder when insurance rates are calculated using the Geospatial Score technology.

The direct result of embodiments of the invention is the accurate determination of an appropriate premium to charge a policyholder based on a more precise calculation of future expected insurance losses to an Entity.

### Working Example

### Example of the Improved Match of Risk to Rate Using Geospatial Score Technology

Although current actuarial ratemaking methodologies used for the pricing of homeowners insurance in the United States include a geographical component, almost all personal lines insurers incorporate geography by varying price by rating territory. These rating territories are typically defined by groupings of zip codes. Zip codes are grouped together based on similar expected loss costs (expected losses for an individual exposure for a policy term). The loss costs used for grouping zip codes are usually on an all perils combined basis. As such, the mix of historical losses by the covered peril is implicitly built into the territorial rates. However, differences do exist in expected loss costs from one property to another within a zip code, due to the differences in risks associated with the topography of the land where the properties are located. The disclosed technology reflects these differences in expected loss costs and enables an insurer to assign a more appropriate rate level to each individual property and thus improve the matching of rate to risk. Many times this will result in a premium savings to the homeowner. As an example consider the following table showing the impact of the Geospatial Score in the pricing of a homeowner's policy for one particular home.

| (1) | Territory Base Rate | $800.00 | | | | | |
|---|---|---|---|---|---|---|---|
| | | Covered Peril | | | | | |
| | | Fire | Wind | Hail | Water | Other | Total |
| (2) | Distribution of Paid | 30% | 15% | 15% | 20% | 20% | 100% |
| | Losses Per Exposure Unit | | | | | | |
| (3) = | Implicit base rate By | 240 | 120 | 120 | 160 | 160 | 800 |
| (1) × (2) | Peril | | | | | | |
| (4) | Relative Risk | 0.850 | 0.800 | 1.200 | 1.080 | 0.970 | 0.965 |
| | Measure For a | | | | | | |
| | Specific Property | | | | | | |
| | Location Based on | | | | | | |
| | Geospatial Variables | | | | | | |
| (5) = | Implicit Base Rate | $204.00 | $96.00 | $144.00 | $172.80 | $155.20 | $772.00 |
| (3) × (4) | Reflecting | | | | | | |
| | Geospatial Score | | | | | | |

| | |
|---|---|
| Dollar Savings to Policyholder | $28.00 |
| Percentage Savings to Policyholder | 3.5% |

Line (1) shows the current territory base rate for Territory A in State X. Using current methodologies this base rate would have been calculated using standard actuarial ratemaking techniques that consider all perils' combined historical loss experience in this territory along with expected trends in claim frequency and claim severity.

Line (2) shows the distribution of losses by peril for this rating territory. This distribution can vary substantially across geographical regions; state to state, within a state, and even by geographical region within a defined rating territory.

Line (3) shows the base rate by peril implicitly built into the current methodology.

Line (4) reflects the value of the present invention and the difference from prior art. These risk relativities will be the results of using geospatial variables as predictor variables in models evaluating the expected loss costs for each peril. For example, the relative risk measure of 0.850 for the fire peril means that the geographic/topographic characteristics for this particular home indicate a reduced risk for loss due to fire of 15% compared to the average risk of fire losses. These geographic/topographic characteristics include but are not limited to the topography of the lot where the home is built along with the direction the lot faces. Therefore, the premium should be reduced to reflect this. In addition, the geographic/topographic characteristics for this particular home would indicate an increased risk of loss due to hail and water as reflected by the relative risk measures of 1.20 and 1.08 respectively. Weighting down the relative risk measures for each of the perils using historical paid losses for this geographic region yield an overall relative risk measure for this property of 0.965. Reflecting this in the premium to be charged this policyholder yields a $28 savings or 3.5% of the policy premium charged using a territory based rate.

Zip codes in the United States were not designed to group homogeneous risks for exposure to insurance losses. Incorporating a Geospatial Score into the premium calculation allows for differences in exposure to insurance losses within the building blocks of rating territories to be reflected in the premiums paid by policyholders. This is a more accurate match of risk to rate for an individual insured property.

Various aspects and embodiments of the disclosed technology for estimating the risk of loss for a location are described above. Various embodiments are described below. The embodiments should not be considered to be mutually exclusive. It is contemplated that various embodiments can be combined.

The disclosed technology provides systems and methods for assessing insurance risk of a property and/or for estimating risk of loss at a geographical address. In one aspect of the disclosed technology, a computer implemented method prepares a list of a plurality of locations, wherein each location in the list is characterized by an address, calculates, by a computer, a score for each location based on geographic data specific for said location, wherein said score is obtained from a plurality of risk factors and is specific for a given peril, combines, by said computer, scores obtained for each peril to arrive at a combined score, and uses said combined score as a factor in the calculation of the insurance premium and/or in underwriting the property. In one embodiment, the property is a home. In one embodiment, geographic data relates to topographical position, slope angle, elevation or slope aspect of the location. In one embodiment, risk factors include one or more of: (i) distance to coast; (ii) windpool eligibility determination; (iii) distance to earthquake faultline; (iv) distance to sink hole, (v) brushfire risk analysis, (vi) elevation, (vii) historical weather patterns, and (viii) additional variables derived from the aforementioned attributes, both singly and in combination.

In one aspect of the disclosed technology, a computer implemented method accesses one or more geographical characteristic(s) associated with a geographical address. For each peril in a plurality of perils, the method computes, by a computer, a corresponding measure of peril indicating a risk of loss at the geographical address from that peril. The corresponding measure of peril is computed based on the geographical characteristic(s) associated with the geographical address. The method computes, by said computer, a combined measure indicating a combined risk of loss at the geographical address from the plurality of perils, wherein the combined measure is computed based on the measures of peril corresponding to the plurality of perils. In one embodiment, the method computes an insurance premium for property at the geographical address based on the combined measure.

In one embodiment, computing a corresponding measure of peril includes applying one or more risk model(s) for that peril to the geographical characteristic(s) associated with the geographical address. In one embodiment, each measure of peril includes a relative risk measure that compares risk of loss at the geographical address from that peril to an average risk of loss from that peril.

In one embodiment, computing a combined measure indicating a combined risk of loss at the geographical address from the plurality of perils includes, for each peril in the plurality of perils, computing a corresponding peril percentage indicating a percentage of paid losses that involve that peril, and computing a corresponding weighted measure of peril based on the peril percentage and the measure of peril. The combined measure is computed based on the weighted measures of peril corresponding to the plurality of perils. In one embodiment, the corresponding weighted measure of peril is the product of the peril percentage and the measure of peril, and the combined measure is the sum of all of the corresponding weighted measures of peril. In one embodiment, the computer implemented method computes an insurance premium for property at the geographical address as a product of the combined measure and a territorial base rate for the geographical address.

In one aspect of the disclosed technology, the disclosed technology also includes a computer executing software, wherein the executed software causes the computer o perform one or more of the embodiments above.

Embodiments of the present invention comprise software and computer components and software and computer-implemented steps that will be apparent to those skilled in the art.

For ease of exposition, not every step or element of the present invention is described herein as part of software or computer system, but those skilled in the art will recognize that each step or element may have a corresponding computer system, processor, or software component. Such computer system and/or software components are therefore enabled by describing their corresponding steps or elements (that is, their functionality), and are within the scope of the present invention.

It will be appreciated that the present invention has been described by way of example only, and that the invention is not to be limited by the specific embodiments described herein. Improvements and modifications may be made to the invention without departing from the scope or spirit thereof.

What is claimed is:

1. A computer implemented method for assessing insurance risk of a property, comprising:
preparing a list of a plurality of locations, wherein each location in said list is characterized by an address;
calculating, by a computer, a score for each location based on geographic data specific for said location, wherein said score is obtained from a plurality of risk factors and is specific for a given peril;
combining, by said computer, scores obtained for each peril to arrive at a combined score; and
using said combined score as a factor in the calculation of the insurance premium and/or in underwriting the property.

2. A computer implemented method as in claim 1, wherein said geographic data relates to topographical position, slope angle, elevation or slope aspect of the location.

3. A computer implemented method as in claim 1, wherein said risk factors include at least one of: (i) distance to coast; (ii) windpool eligibility determination; (iii) distance to earthquake faultline; (iv) distance to sink hole. (v) brushfire risk analysis, (vi) elevation, (vii) historical weather patterns, and (viii) additional variables derived from the aforementioned attributes, both singly and in combination.

4. A computer implemented method as in claim 1, wherein said property is a home.

5. A computer implemented method for estimating risk of loss at a geographical address, comprising:
accessing at least one geographical characteristic associated with the geographical address;
for each peril in a plurality of perils, computing, by a computer, a corresponding measure of peril indicating a risk of loss at the geographical address from that peril, wherein the corresponding measure of peril is computed based on the at least one geographical characteristic associated with the geographical address; and
computing, by said computer, a combined measure indicating a combined risk of loss at the geographical address from the plurality of perils, wherein the combined measure is computed based on the measures of peril corresponding to the plurality of perils.

6. A computer implemented method as in claim 5, wherein computing a corresponding measure of peril comprises applying at least one risk model for that peril to the at least one geographical characteristic associated with the geographical address.

7. A computer implemented method as in claim 5, wherein each measure of peril comprises a relative risk measure that compares risk of loss at the geographical address from that peril to an average risk of loss from that peril.

8. A computer implemented method as in claim 7, wherein computing a combined measure indicating a combined risk of loss at the geographical address from the plurality of perils comprises:
for each peril in the plurality of perils:
computing a corresponding peril percentage indicating a percentage of paid losses that involve that peril, and
computing a corresponding weighted measure of peril based on the peril percentage and the measure of peril; and
computing the combined measure based on the weighted measures of peril corresponding to the plurality of perils.

9. A computer implemented method as in claim 8, wherein:
the corresponding weighted measure of peril is the product of the peril percentage and the measure of peril; and
the combined measure is the sum of all of the corresponding weighted measures of peril.

10. A computer implemented method as in claim 9, further comprising computing an insurance premium for property at the geographical address as a product of the combined measure and a territorial base rate for the geographical address.

11. A computer implemented method as in claim 5, further comprising computing an insurance premium for property at the geographical address based on the combined measure.

12. A computer executing software for estimating risk of loss at a geographical address, wherein the executed software causes the computer to perform steps comprising:
accessing at least one geographical characteristic associated with the geographical address;
for each peril in a plurality of perils, computing a corresponding measure of peril indicating a risk of loss at the geographical address from that peril, wherein computing the corresponding measure of peril takes into account the at least one geographical characteristic associated with the geographical address; and
computing a combined measure indicating a combined risk of loss at the geographical address from the plurality of perils, wherein the combined measure is computed based on the measures of peril corresponding to the plurality of perils.

13. A computer as in claim 12, wherein computing a corresponding measure of peril comprises applying at least one risk model for that peril to the at least one geographical characteristic associated with the geographical address.

14. A computer as in claim 12, wherein each measure of peril comprises a relative risk measure that compares risk of loss at the geographical address from that peril to an average risk of loss from that peril.

15. A computer as in claim 14, wherein computing a combined measure indicating a combined risk of loss at the geographical address from h plurality of perils comprises:
for each peril in the plurality of perils:
computing a corresponding peril percentage indicating a percentage of paid losses that involve that peril, and
computing a corresponding weighted measure of peril based on the peril percentage and the measure of peril: and
computing the combined measure based on the weighted measures of peril corresponding to the plurality of perils.

16. A computer as in claim 15, wherein:
the corresponding weighted measure of peril is the product of the peril percentage and the measure of peril; and
the combined measure is the sum of all of the corresponding weighted measures of peril.

17. A computer as in claim 16, wherein the executed software causes the computer to perform further steps comprising computing an insurance premium for property at the geographical address as a product of the combined measure and a territorial base rate for the geographical address.

18. A computer as in claim 12, wherein the executed software causes the computer to perform further steps comprising computing an insurance premium for property at the geographical address based on the combined measure.
